(19) United States
(12) Patent Application Publication
(10) Pub. No.: US 2006/0085325 A1
(43) Pub. Date: Apr. 20, 2006

(54) System, method, and computer program for assessing risk within a predefined market

(75) Inventors: Shahnaz Jammal, Kuala Lumpur (MY); Corinne Neale, Singapore (SG); Prabhaharan Rajendra, Petaling Jaya (MY); Alan Wong, Sandakan (MY); Andy Yang, Sydney (AU)

Correspondence Address: ROTHWELL, FIGG, ERNST & MANBECK, P.C., 1425 K STREET, N.W., SUITE 800, WASHINGTON, DC, 20005, US

(73) Assignee: The McGraw Hill Companies, Inc., New York, NY (US)

(21) Appl. No.: 11/293,247

(22) Filed: Dec. 5, 2005

Related U.S. Application Data
(63) Continuation of application No. 09/646,728, filed on Apr. 27, 2001.
(60) Provisional application No. 60/078,793, filed on Mar. 20, 1998.

(51) Int. Cl. G06Q 40/00

(52) U.S. Cl. 705/38

(57) ABSTRACT

A system and method for measuring or quantifying the probability of default of a borrower. Credit factors from companies that banks have extended loans to are inputted and collected into a processor. The method employs a process utilizing an optimization function and a standard multivariate nonlinear regression to process client information and to provide an output value whose value is indicative of the likelihood or risk of default by a particular borrower.

### BACKGROUND OF THE INVENTION

1. Field of the Invention

The present invention relates generally to financial management systems, and more particularly to data processing systems for predicting the likelihood (or risk) of particular borrowers defaulting on their financial obligations.

2. Related Art

The use of standard multivariate non linear regression techniques are known for financial analysis. These techniques are described in: Ohlson, J., J. Accounting Research pp. 109-131 (Spring 1980); Steenackers & Goovaerts, Insurance: Mathematics and Economics, 8:31-34(1989); Zavgren, C., J. Accounting Literature 1:1-38 (1983); Boyes, W. J. et al., J. Econometrics 40 (1989), Beaver, W., J. Accounting Research (Spring 1974); Myers, J. H., & E. W. Forgy, J. American Statistical Association (September 1963); Altman, E., J. Finance (September 1968); Edmister, R. O., Journal of Financial and Quantitative Analysis (March 1972); Deakin, E. B., The Accounting Review (January 1976); F. L. Jones, J. Accounting Literature, Vol. 6 (1987); Steenackers, A. and Goovaerts, M., Insurance: Mathematics and Economics, Vol. 8 (1989); Dougherty, C., Introduction to Econometrics, Oxford University Press (1992); Hosmer, D. W. et al., Applied Logistic Regression (1989); Collett et al., Modelling Binary Data (1996); Pindyck & Rubinfeld, Econometric Models and Economic Forecasts, McGraw-Hill International Editions (1991); Press et al., Numerical Recipes in C, Cambridge University Press (1994); Microsoft Excel Visual Basic for Applications Reference, Microsoft Press (1994).

The “credit worthiness” of a particular company or particular borrower, the two terms being used interchangeably, or of a portfolio or predefined set of borrowers is a measure of the ability of that particular company or of all companies within the portfolio to repay their financial obligations (i.e., debt) or to pay the agreed upon amount of interest on their debt. The “ability of a company to repay or service a debt” is accepted in the banking community to be a function of the company's “fundamental financial characteristics.”

“Fundamental financial characteristics” differ in nature depending on the type of entity, its business and the economic environment or market in which that entity, company or set of companies operate. In the banking community, these fundamental financial characteristics are called “credit factors.” Common examples of credit factors include: (1) financial ratios derived from a company's balance sheet or income statement (e.g., total debt/total assets, interest expense/gross income, etc.); (2) industry information (e.g., growth, margins, etc.); and (3) character information such as reputation, experience, track record of senior management, etc.

Within a bank or other lending entity, credit officers have the responsibility for analyzing companies' credit factors. That is, credit officers are charged with ascertaining which companies have or have not in the past honored their financial obligations. Through these observed patterns credit officers attempt to build, in their own mind, a “credit memory” of the most striking characteristics of the companies who will or will not repay their credit obligations. The latter category of companies are labeled “defaulting companies.”

There are several degrees of “default.” These range in severity from a company missing one financial obligation payment after an acceptable grace period, to a company becoming bankrupt. “Credit risk” in the following description is meant as the bank or lender's risk of loss resulting from the default of clients or banking counterparties.

Few lending institutions in developing countries (e.g., southeast Asia) collect credit factors on the companies to which they have extended loans. Even those lenders who do collect credit factors, none process this information to derive a measure of credit worthiness on individual clients. The measure of credit worthiness would influence the banks' decision to extend a loan and how the resulting credit risk should be managed (e.g., through interest pricing, reserving in anticipation of default, etc.). This practice developed in light of the booming economies of southeast Asia during the past 10 years and up until the second quarter of 1997. Very few financial defaults occurred during that period resulting in banks being eager to lend irrespective of the associated risk.

Applicants recognized that the high level of debt among southeast Asian companies were the first signs of a possible economic slow-down and that more defaults were likely to happen. Because of the established practice in this financial market of not analyzing credit factors and the lack of methodology and system to do so, Applicants anticipated that local banks would not be able to monitor nor to manage the declining credit-worthiness of their clients. The recent financial crisis in southeast Asia shows that Applicants' concern were well founded. Applicants' testing of regional interest in southeast Asia for an automated process aiming at quantifying the credit worthiness of borrowing companies using locally available credit factors, lead to the development of the present invention.

The consulting firm of Oliver, Wyman & Company, of New York, N.Y., has developed a method for predicting borrower default that differs from the present invention and is not adapted for predicting risk in emerging countries. Though it is not known whether there has been any publication or commercialization of any system or method based on their method, Oliver, Wyman & Company is believed to have developed a technique of linear regression to obtain a probability of default for a borrower (i.e., the regression function they use is a linear function). By contrast, the present invention uses a logistic function which, as explained below, is a significant improvement. To estimate the weights which are required to obtain the probability of default, Oliver, Wyman is believed to use the technique called the method of least squares, whereas the present invention uses a logistic function and the method of maximum likelihood which is more accurate for non-linear functions. Finally, the Oliver, Wyman definition of predictive accuracy for the method they have developed, is the statistical measure known commonly as “R-square.” If the R-square is high enough, the weights are retained and the probabilities of default generated are deemed to be accurate. There is however no demonstrated mathematical link between the value of the common statistical measure known as R-square, and the predictive accuracy of the Oliver, Wyman method. By contrast, the test of the accuracy of the probabilities of default quantified by the invention is the predictive accuracy observed on actual samples of borrowers, and expressed as a percentage of these borrowers whose default or non default events have been correctly anticipated. The Oliver, Wyman approach additionally suffers from the drawbacks described below.

### SUMMARY OF THE INVENTION

The present invention meets the above-mentioned needs by providing a system, method, and computer program product for assessing risk within a predefined market. More specifically, in one illustrative embodiment of the present invention, a probability of default quantification method, system, and computer program product (collectively referred to herein as “system”) assists banks and other lenders in emerging countries or, by extension, any entity extending credit to borrowers in a predefined market or economic environment.

The present invention operates by processing client information (i.e., the credit factors) that banks have available to derive a measure of credit-worthiness for their clients individually, and for a client's entire portfolio as a group or set of borrowing entities in a particular economic environment. The measure of credit worthiness derived is the underlying company's(ies') probability of default (i.e., a percentage number between 0% and 100% representing the likelihood of credit obligation default).

The present invention has particular usefulness, though not limited thereto, in emerging countries (e.g., non G10 countries—an informal group consisting of the ten largest industrial economies of the world) because of the absence of reliable public information which could be used as “market proxies” to assess credit risk. Market proxies include, for example, publicly available equity prices or corporate bond yields. The system thus fills an important information gap on the credit worthiness of companies in emerging countries. The system however has applications in any country for the purpose of assessing the credit worthiness of companies or entities, even though alternative ways to assess credit risk exist in developed countries such as through publicly available information.

Compared to the noted Oliver, Wyman approach, the system of the present invention has particular advantages to predict credit risk. For banks or any institution extending credit to companies or other entities in emerging countries who want to quantify the credit worthiness of their corporate or commercial clients, one of the alternatives to the system of the present invention is to apply to their loan portfolio the credit risk quantification tools used by banks in the U.S., Japan or in Western Europe. For background purposes, these alternative tools belong to two main categories.

First, these known tools use market proxies to assess credit risk. This is the most common approach used by banks in the U.S., Japan and Western Europe. The assumption made when market proxies are used is that the market price of equities or corporate bonds reflect all information relevant to determine the credit worthiness of companies. Another way to state this assumption is that equity and corporate bond markets are so efficient and transparent that equity and corporate bond prices fairly represent the value of companies and thus their likelihood of defaulting. This of course may only be true in the most regulated, shareholder driven and largest markets. None of these characteristics hold true in most countries, especially in emerging countries.

Second, these tools use credit factors calculated for U.S. or Western Europe companies and comparison to events of default having occurred in the U.S. or Western Europe. This is the approach used by U.S. rating agencies and this is also the approach believed to be used by Oliver, Wyman. The assumption made when this approach is used is that the same credit factors, (i.e., those of American or Western European companies) should be used for any company, irrespective of its accounting and cultural conventions. As all banks or entities extending credit in emerging countries use different credit factors to reflect the information available and relevant for their company clients, using this approach implies that the above “U.S.” credit factors need to be recalculated. In the process, important local information not captured by these U.S. credit factors may be lost.

The system of the present invention offers significant advantages over the two above-mentioned approaches. These significant differentiating advantages and novel features are mentioned here and described in more detail below.

One advantage of the present invention is that the input into the system is more convenient because it already exists and is better suited for analyzing the local financial environment or market. The system uses as input the credit factors already collected, for example, by local banks or local users wanting to use the system. This is important because in most countries market proxies do not exist or do not provide a fair representation of the likelihood of default for companies and, hence, cannot be used. This is also important because of different financial reporting conventions between the western world and emerging countries which would lead to local information important to assess the probability of default getting lost in the process (e.g., on the use of intra-group cash flows or guarantees).

Another advantage of the present invention is that, in an embodiment, the system is suited to emerging countries.

Another advantage of the present invention is that, as further described below, it uses a non-linear regression technique as one of its underlying techniques. This contrasts with the second alternative tool described above which assumes that the probability of default of a company is linearly related to individual credit factors. Significant test runs by the Applicants demonstrate conclusively that the relationship between a credit factor and the probability of default is not linear in emerging countries.

A further advantage of the present invention is that it uses a database of local companies or entities within the market or economic environment of interest as a reference to apply the non-linear regression technique. This contrasts with approaches common in the western world, for instance those of most U.S. rating agencies, which use a database of U.S. companies as a reference. For instance if the system is used to assess the probability of default of Thai companies, then the database underlying the system will contain Thai companies or companies from similar neighboring countries. Applicants have conducted tests which demonstrate conclusively that using U.S. companies as reference data leads to significantly over estimated probabilities of default and bias the results.

Yet still, a further advantage of the present invention is that it produces more stable results. The two known approaches, described above, have been found to produce unstable results. That is, depending on the sample of companies for which a probability of default is quantified, the patterns of credit worthiness identified by these methodologies fluctuate. This means that the same company could be identified with these approaches as having both a high probability of default and a low probability of default depending on which sample the company belongs to.

Further, the present invention allows a lending institution to assess the impact of future economic or industrial scenarios. In an embodiment of the present invention, the credit factors input into the system are weighted averages of the last three years of credit factors in the form of ratios or codes. Consequently, future scenarios can be accommodated through the manual input of a new “rolled-over” weighted average credit factor based on the value of credit factors in the two prior years and on how the scenario will affect future credit factors in the coming year. Any such scenario is processed by the system to quantify the probability of default of any company or group of companies in the year of the scenario.

The present invention results in a new and better perspective on the credit worthiness of companies in emerging countries. The present invention provides processed information that was previously not available, and that is very useful to manage the assets of banks. In particular, the present invention proves useful to banks operating in emerging countries where there exists an absence of market proxies for credit risk, such as reliable and liquid equity indices. The present invention also significantly improves on previous practices due to its automated mathematical process that allows the consistent and rapid quantification of probabilities of default. The present invention further introduces analytical techniques in the field of emerging market credit assessment, which was up to now mostly subjective in nature. Finally, the system is commercially different from possible alternatives in that it produces more stable and accurate results.

Further features and advantages of the invention as well as the structure and operation of various embodiments of the present invention are described in detail below with reference to the accompanying drawings.

### BRIEF DESCRIPTION OF THE FIGURES

The accompanying drawings, which are incorporated herein and form part of the specification, illustrate the present invention and, together with the description, further serve to explain the principles of the invention and to enable a person skilled in the pertinent art to make and use the invention.

FIG. 1 is a block diagram illustrating the system architecture according to an embodiment of the present invention.

FIG. 2 is a diagram illustrating the data structure of the general memory database according to an embodiment of the present invention.

FIG. 3 is a is a flow diagram illustrating how the reference database is populated according to an embodiment of the present invention.

FIG. 4 is a flow diagram illustrating the probability of default processing according to an embodiment of the present invention.

FIG. 5 is a flow diagram illustrating the determination of optimal weights for the probability of default processing according to an embodiment of the present invention.

FIG. 6 is a block diagram illustrating the format of the general memory database according to an embodiment of the present invention.

FIG. 7 is a flow diagram illustrating the probability of default projection processing according to an embodiment of the present invention.

FIG. 8 is a block diagram illustrating the graphical output capabilities according to an embodiment of the present invention.

FIGS. 9-13 are window or screen shots of graphs generated by the graphics package coupled to the present invention.

FIG. 14 is a block diagram of an example computer system useful for implementing the present invention.

### DETAILED DESCRIPTION OF THE PREFERRED EMBODIMENTS

### Table of Contents

I. System Architecture

II. System Inputs

III. System Overview

IV. Assessing Risk: Pattern Recognition Processing

V. Projections

VI. Output Graphics Facility

VII. Stability Processing

VIII. Example Implementations

IX. Conclusion

### I. SYSTEM ARCHITECTURE

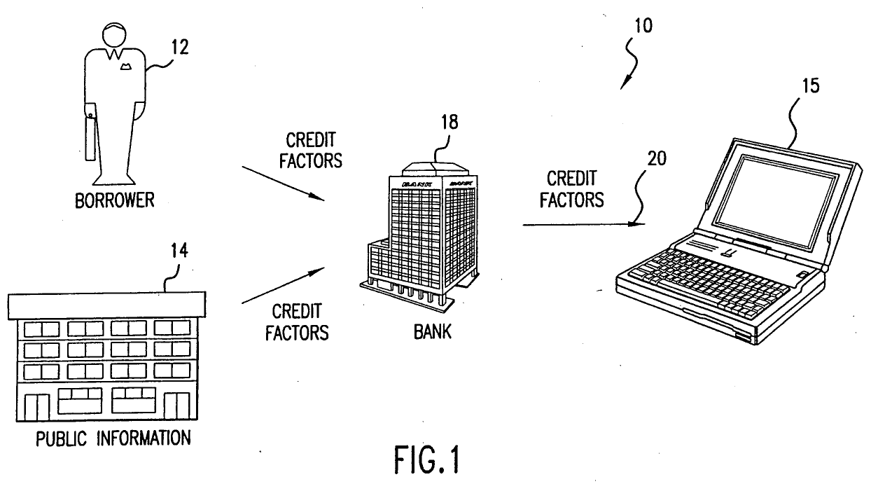

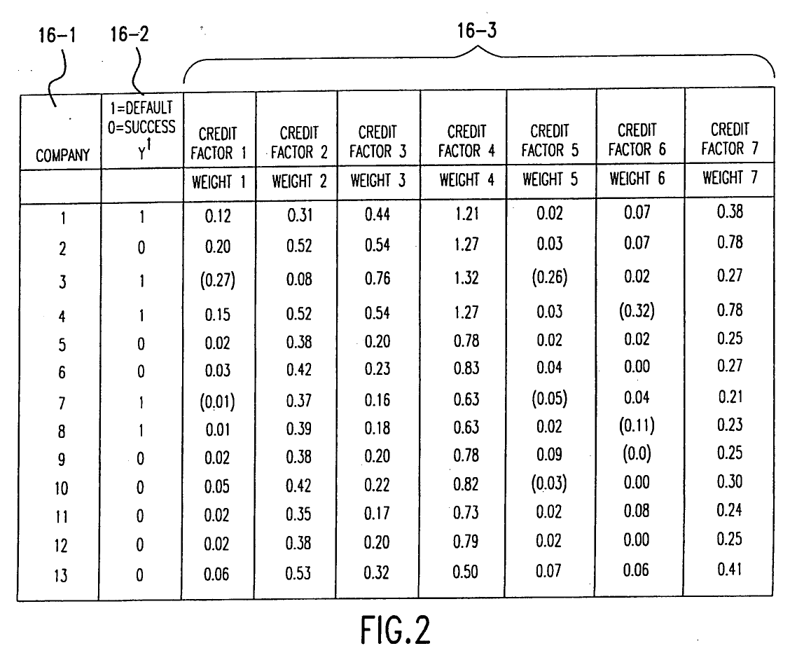

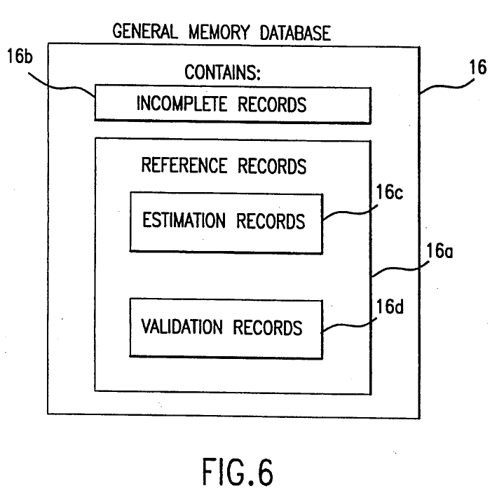

Referring to FIGS. 1 and 2, a system 10 according to the present invention includes three parts: a credit or general memory database 16, a processor 15 for inputting financial data applying pattern recognition processing to that data, and an output graphic facility utilized in step 44 (as described below). The system 10 uses as input the credit factors 20 already collected on individual companies, i.e., any credit factor currently available, by the banks wanting to use the system 10. As illustrated in FIG. 1, these credit factors 20 come from the companies the banks have extended loans to or otherwise taken credit risk on, or from publicly available information, e.g., a borrower 12 or any source of public information 14. The credit factors 20 collected by any individual bank using the system 10 from companies or publicly available sources is input manually or electronically by the computer processor 15 into the general memory database 16. Illustratively, the database 16 can be a part of the processor 15. The architecture of the general memory database 16 is displayed in FIGS. 2 and 6.

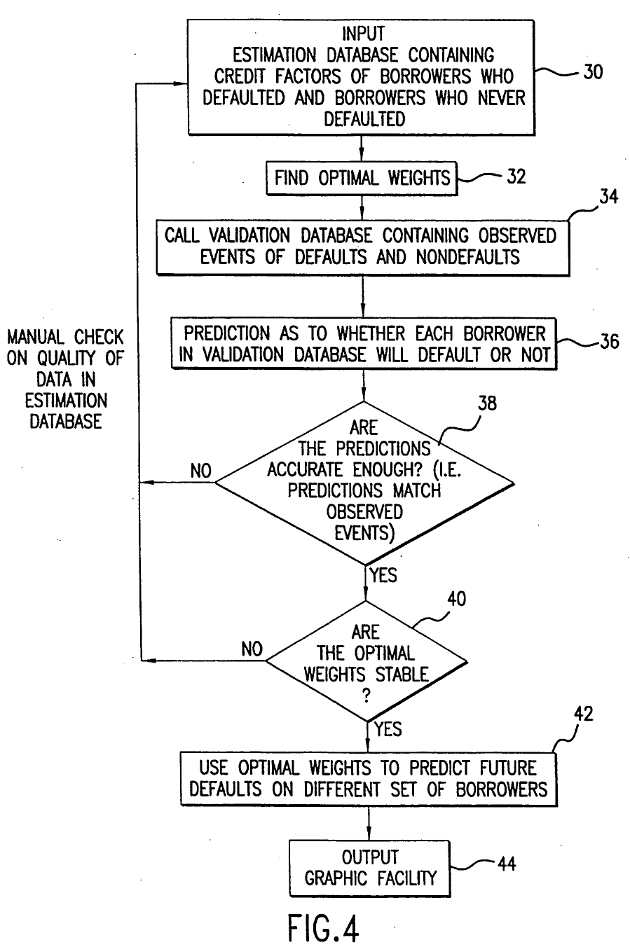

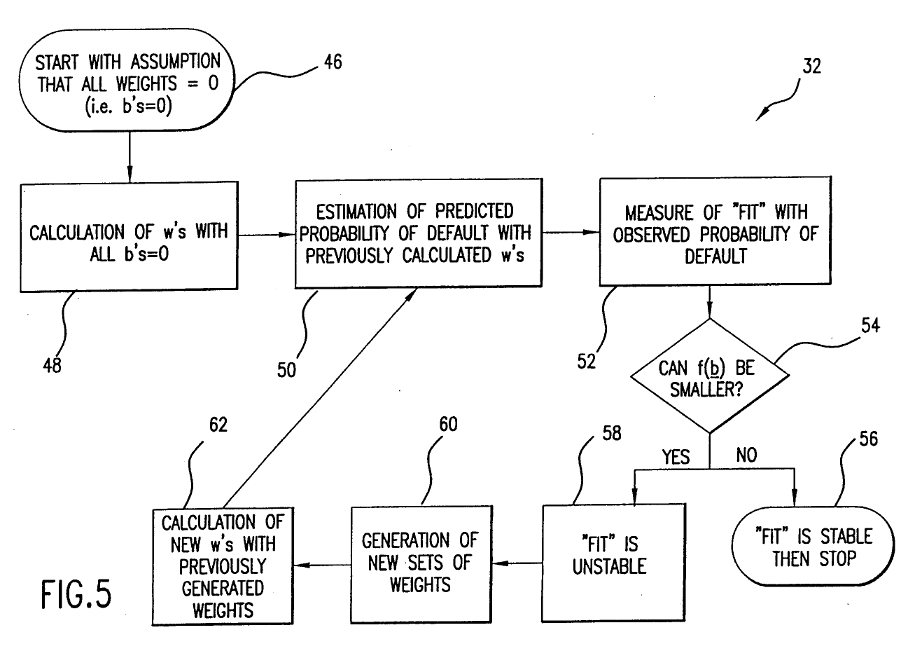

FIG. 2 illustrates the data that needs to be input and the format to be followed in the general memory database 16. A first column 16-1 contains a code for each company or borrower 12 for secrecy reasons. A second column 16-2 contains a record of whether the company has ever defaulted on one of its financial obligations in the past (i.e., 1=yes, and 0=no). A set of columns 16-3 store three year averages for each credit factor 20, the particular credit factor 20 being identified at the top of its column. These credit factors 20 can be accounting ratios, industry ratios, or subjective quality figures. Each emerging country and each bank can use different credit factors 20. There is no limitation on the number of credit factors that can be used. Different industries may require different credit factors 20. Once a bank using the system 10 has decided on a set of credit factors 20, for instance by a particular industry, the same credit factors 20 need to be collected for all of the bank's corporate or commercial borrowing clients within this industry or pre-determined economic environment. As will be explained in more detail below with reference to FIGS. 4 and 5, a weight, b, is associated with each credit factor 20.

### II. SYSTEM INPUTS

When the system 10 is initialized or first set up (i.e., before the first time the system 10 is used), the user conducts a manual company examination and selection process. The first part of the examination and selection process identifies companies where any of the required credit factors 20 is not available. In this case, these companies cannot be entered into the general memory database 16 and its probability of default cannot be assessed. Such incomplete records can be stored in a sub-section 16b of the general memory database 16 as shown in FIG. 6.

Second, companies for which it is not known whether the company has ever defaulted on one of its credit obligation, but all of the credit factors 20 are available, are identified. In this case, these companies can be entered into the general memory database 16 and their probabilities of default can be assessed. The probability of default processing will be explained below with reference to the flow diagram of FIG. 4. These companies, however, cannot be used in fitting the pattern recognition processing to the information available locally (which fitting process is also described in FIG. 5) That is, none of the companies can be inputted into a sub-section of the general memory database 16 called a reference database 16a which will be described below with reference to FIG. 6.

Lastly, companies where all credit factors 20 and whether they have ever defaulted are known, are identified. In this case, these companies can be entered into both the general memory database 16 and more particularly, into its sub-section, reference database 16a, as illustrated in FIG. 4.

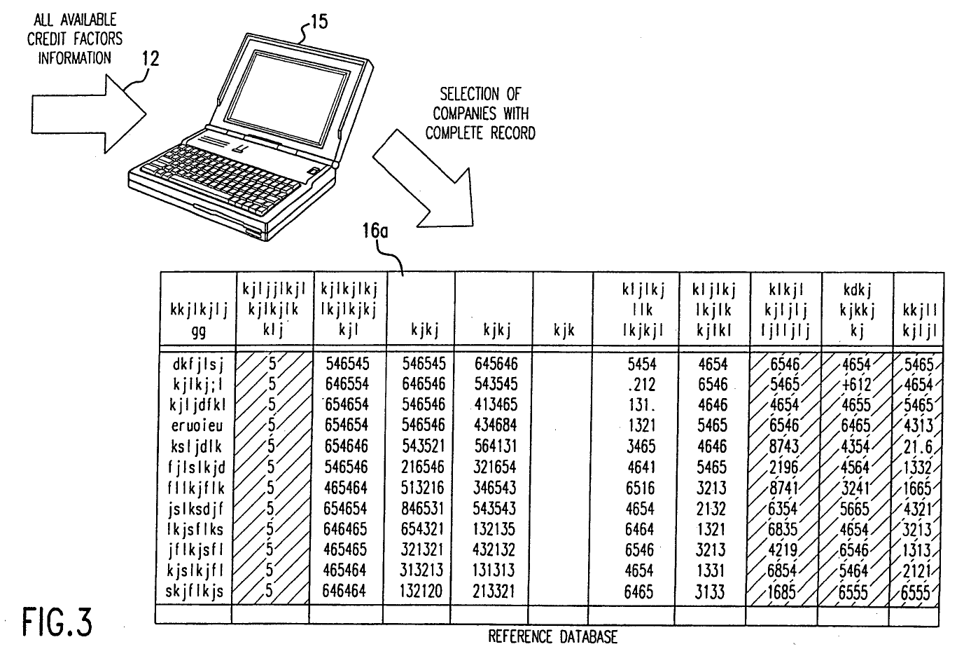

Further, in an embodiment of the present invention, before any of the companies are entered into the reference database 16a, as illustrated in FIG. 3, a test of homogeneity can be conducted to identify “outlier” companies. The test ensures that all companies stored in the reference database 16a for estimation and testing purposes are representative of the type of borrowers in a user's credit portfolio. In addition, the test picks up fraud or false data among the credit factors 20 and tags the corresponding companies. The present invention determines outlier companies via a process which compares the credit factor 20 data across all companies in the reference database 16a. This process analyzes each credit factor 20 independently. In an embodiment, the mean and standard deviation are calculated for each credit factor, and the value of the credit factor for each company is standardized by subtracting the mean and dividing by the standard deviation. Companies with standardized values greater than 2.5 are identified as “outliers” and removed from the reference database 16a. This process is repeated until no outliers can be identified from the pool of retained companies in the reference database 16a.

As a result of the architecture or format of the data base 16 as illustrated in FIGS. 2 and 6, and type of information contained therein, the reference database 16a is the same as for the general memory database 16, since the reference database 16a is a sub-section of the general memory database 16. The difference between these two databases is that the reference database 16a contains only the companies on which a complete record of credit factors 20 and previous history of default are available.

### III. SYSTEM OVERVIEW

As shown in FIG. 3, once the reference database 16a is established or every time new company data is entered into the general memory database 16, the system 10 applies its pattern recognition processing to the reference database 16a to derive patterns based on past experience of the relationship between the credit factors 20 of companies and their observed default events. The way these patterns are developed is described below.

A purpose of the system 10 is to calculate the probability of a borrower 12 defaulting on its debt obligations. Many traditional credit analysis approaches predict default by classifying the borrower into one of two groups—“good” or “bad.” In reality, however, borrowers can be classified into many different groups, each with their own level of credit worthiness. For example, the credit worthiness of an internationally renowned multinational corporation can be very different from that of a small company starting up using family savings. In between these two extremes are numerous borrowers 12 who are not quite as credit worthy as the multinational but much more credit worthy than the small family business.

The system 10 of the present invention represents the range of credit worthiness observed in the market place as a “probability of default”, i.e., a number which can take any value lying between zero and one. If the system 10 assigns a probability of default close to zero (0) for a specific borrower 12 this means that the system 10 has classified the borrower as being highly unlikely to default on debt repayment obligations. Conversely, a probability of default close to one (1) means that the system 10 has classified the borrower as being highly likely to default. A probability of default of 0.5 represents a borrower who is classified as belonging to the “middle of the credit worthiness range” group.

By collecting relevant financial and non-financial information on borrowers 12, information previously referred to as “credit factors,” it is possible to predict future defaults as follows. First, as shown in FIG. 4, an input step 30 collects sufficient historical credit factors 20 on the past performance of borrowers. Then, it is possible to analyze this information by comparing the credit factors 20 of companies who have in the past defaulted and those who have never defaulted. It is also possible to find within this information “warning signals” that are indicative of impending default. These “signals” can be consolidated into particular patterns representing the historical relationship between the values of credit factors 20 and the observed incidences of default.

For example, many businesses that default on their debt repayment obligations may show financial statements that get progressively worse as the date of default approaches. If therefore in the future, a business is observed whose financial statements show a close match to those of a business that defaulted on a loan in the past. It is likely that such businesses also are likely to default. By calculating a probability of default, P, the system 10 answers the question: “how likely?”

Due to the complexity and volume of the modern business environment and the great volume of credit factors 20, it has become necessary to collect information on numerous credit factors 20. Consequently, it is necessary to use a contemporary computer to find the patterns, which link the values of credit factors 20 and default. The system 10 uses automated pattern recognition processing to find patterns between the values of past credit factors 20 and the occurrence of past defaults, and then uses these patterns on prospective or existing borrowers in order to classify these borrowers according to their probabilities of default. The system 10 calculates these probabilities using the following methodology, as represented in FIG. 4, which will now be described.

### III. ASSESSING RISK: PATTERN RECOGNITION PROCESSING

Referring to FIG. 4, the step 30 inputs data into the pattern recognition processing and, in particular, to the reference database 16a, which stores the historical credit factors 20 available on individual borrowers 12 together with a reference as to whether they have defaulted in the past. All of these records, as illustrated in FIG. 6, are collectively referred to as “reference records.”

The reference database 16a is divided into two sections. One section, called the “estimation database” 16c, is used by the system 10 to find patterns, while the other section, called the “validation database” 16d, is used to test the accuracy of the default predictions. The structure and inputs of the two sections of the reference database 16a are described in FIG. 2. FIG. 6 illustrates how the estimation records and validation records within the estimation database 16c and validation database 16d, respectively, relate to the information maintained within the general memory database 16.

Which company is made to belong to which section of the reference database 16a is left to the user and has no impact on the rest of the process described below, as long as the two parts of the reference database are of similar size. The user may, for instance, arbitrarily decide to split a reference database containing 100 companies, by allocating 50 to the estimation database 16c and 50 to the validation database 16d.

The logic underlying the system 10 is to use the estimation database 16c to find the particular combination of credit factors 20, and weights, b, to be applied to the credit factors 20, which will lead to identify the defaults recorded in the validation database 16d with a sufficiently high level of accuracy. This combination will then be retained by the system 10 as a basis for calculating probabilities of default on an on-going basis for all companies in the general memory database 16 and for any future borrower 12.

After the data has been input in step 30, the system 10 carries out step 32 as shown in FIG. 4 to determine a set of weights, b, which is “optimal” in terms of explaining past defaults once they are applied to past credit factors 20 in the estimation database 16c. Step 32 is a module of steps 46 to 62, which are described with reference to FIG. 5. Because of the way the processing is written and programmed in the system 10, steps 46 to 52 are executed simultaneously.

There are numerous borrowers 12 in the estimation database 16c, some of which have defaulted in the past. What is common to all these borrowers, however, is that the same credit factors 20 are recorded for each borrower. However, not every credit factor 20 is of equal importance in explaining past default for each borrower. Some credit factors 20 are more important than others for specific borrowers. The system 10 represents this importance by assigning a number called a “weight” to each credit factor 20. For example, if there are five credit factors 20, then five weights will be assigned.

Referring to FIG. 5, the system 10 calculates, in step 50, a probability of default, P, for each individual borrower 12 by combining the values of the credit factors 20 and the weights, b, by using the following equations:

$$\begin{matrix}{P}_{i} = {( 1 + {ⅇ}_{i}^{- w} )}^{- 1} \\ where \text{:} & EQUATION ( 1 ) \\ {w}_{i} = {b}_{0} + {\sum }_{j = 1}^{m} {b}_{j} {x}_{ij} & EQUATION ( 2 )\end{matrix}$$

The meaning of the symbols appearing in EQUATION (1) and EQUATION (2) are summarized in TABLE 1 below:

TABLE 1

| SYMBOL | DEFINITION |
|---|---|
| xᵢⱼ | Values of a credit factor j for a particular borrower i |
| b₀ | The constant of the logistic function |
| bⱼ | The individual weights attaching to each credit factory j |
| wᵢ | An individual combination of weights, b, and credit factors |
| | for each borrower i. |
| m | Total amount of credit factors |

The expression (1+e^{-w}ᵢ)⁻¹ is called a “logistic function,” and one illustrative form of this logistic function is described in the above-cited Hosmer, D. W. et al., Applied Logistic Regression (1989) at Chapter 1, Page 6 (hereinafter “Hosmer”). One skilled in the relevant art(s) would recognize that other logistic functions can be used in the present invention. Probability P is the parameter which indicates whether a specific borrower 12 will default, for a particular combination of weights, b, and the particular logistic function being used. As mentioned above, the parameter P varies between zero (0) and one (1).

The technique of equating a function (e.g., the combination of weights, b, and credit factors 20) to a probability (e.g., the probability of default, P) is known as “regression.” An illustrative embodiment of this technique can be found in Hosmer at Chapter 1, Page 1. Other references disclose a regression technique which could be employed by the system 10. Many regression functions can be used by the system 10 and there are consequently many different types of regression equations. The system 10 makes use, in one illustrative embodiment of the present invention, of the regression function called logistic function described in EQUATION 1. Because the system 10 applies the logistic function to a combination of several credit factors 20, this part of the process is called “multivariate logistic regression.”

As shown in FIG. 5, the system 10, in one embodiment, starts the regression process by assuming or estimating in step 46 the values of the weights, b, to be all equal to zero (0). These values b=0 are then substituted, in step 48, into EQUATION (2) to calculate the corresponding values of w. Then in step 50, the probabilities, P, of all companies in the estimation database 16c are calculated using EQUATION (1). These probabilities, P, are not kept in any database. They are only used as part of the calculations described in step 52 below.

By listing all the calculated probabilities, P, one per borrower 12, in step 50, the system 10 can represent the probability of default for all borrowers in the estimation database 16c as a vector, i.e., a series of numbers between zero (0) and one (1). For example, if there were 3 borrowers in the estimation database 16c and the system 10 calculates the probabilities, P, of default of the first borrower as 0.3, the second as 0.8, and the third as 0.4, then these three numbers can be arranged to form a first vector (0.3, 0.8, 0.4).

It is also known at this stage, because it is recorded in the estimation database 16c whether each of the borrowers in the estimation database 16c actually have defaulted. The system 10 can therefore produce a second vector of observed defaults recorded in the estimation database 16c by assigning the number one (1) to signify a default condition and the number zero (0) to signify non-default. In the above example, and as shown in the first three entries of column 16-2 of FIG. 2, the system 10 forms a second vector (1,0,1).

The system 10 then compares, in step 52, the above two vectors to assess how closely they match each other. In order to do so, the system 10 has to be able to recognize what a “good fit” between two vectors is, and out of various good “fits” find the “best” or “most optimum” pattern.

In accordance with an illustrative embodiment of the present invention, system 10 defines a “good” fit in terms of the values of the following function:

$$f ( \underline{b} ) = {\sum }_{l}^{n} \{ ln ( 1 + {ⅇ}^{{w}_{i}} ) - {Y}_{i} {w}_{i} \} \qquad EQUATION ( 3 )$$

The meaning of the symbols appearing in EQUATION (3) are summarized in TABLE 2 below:

TABLE 2

| SYMBOL | DEFINITION |
|---|---|
| wᵢ | An individual combination of weights, b, and credit factors |
| | for each borrower i. |
| Yⱼ | numbers which take the value zero (0) if the borrower i has |
| | not previously default, and one (1) if the borrower has |
| | previously defaulted |
| n | Total amount of companies (clients) |

Steps 50 to 62 are used by the system 10 to find a set of weights, b, which returns the smallest possible value for f(b) as calculated by EQUATION (3). What “smallest possible value” means depends on the value of the estimation records themselves in the particular estimation database 16c used, and is of no consequence to the rest of the process, as long as a minimum value for f(b) can be found in Step 54. What is relevant is the ability, through steps 50 to 62, to further decrease the value of f(b). Step 54 determines whether the value of the function f(b) as calculated by EQUATION (3) can be made smaller as will be explained below. If by reiterating through steps 50 to 62 the change in value of the proprietary function f(b) is small, then the two vectors are considered to have a good “fit.” “Small” in this respect is illustratively defined, in one embodiment, as equal or less than 10⁻⁷. If the function cannot be made smaller (i.e., smaller than 10⁻⁷), by further reiterating through steps 50 to 62, then the process determines in step 56 that the fit is stable. If this function can be made smaller, the fit is deemed unstable in step 58 and the process of system 10 moves to step 60, where as will be explained a new set of weights, b, is generated to again be applied for EQUATIONS (1) and (3) as described above with respect to steps 50 and 52.

The technique used to find the values of the weights which return the, smallest value for the function f(b) is an optimization technique called “Maximum Likelihood Estimation”, one illustrative embodiment of which is described in the above-cited Collett et al., “Modelling Binary Data” (1996) at Chapter 3, Page 49. It is acknowledged that there are other publications, which describe maximum likelihood estimation. The values of the weights, b, which minimize the proprietary function f(b) are called the “optimal” weights.

The principles behind the maximum likelihood estimation technique is a process of automated iterative “trials and errors”, i.e., by iterating possible values for the weights, b, a large number of times into EQUATION (3).

There are available many standard maximum likelihood estimation iteration techniques to determine the possible value of the weights. The illustrative embodiment technique currently used by step 62 of the system 10 is to start the process with a given value for the weights, increase each weight by a small amount generated randomly and independently for each weight, b, out of a user defined range, re-calculate the value of the function f(b), retain only that set of weights, b, which generates the smallest value for the function f(b), and stop reiteration in step 56 when the function f(b) is determined in step 54 to reach its lowest value, i.e., any further change in weight does not further decrease the value of the proprietary function f(b).

The exact iteration technique to be used by the system 10 depends on the type of computer platform being used to run the system 10. This has to be decided up-front before the system 10 is used. For example if the database and graphic capabilities of the software program Microsoft® Excel are being used, the new weights, b, can be generated by running the “Solver” function which is part of the Excel software package. Further technical details on this software package are found in the above-cited Microsoft Excel Visual Basic for Applications Reference, Microsoft Press (1994).

As noted above, the process reiterates through steps 50 to 62 of FIG. 5, until step 54 determines that the set of values of the function f(b) has been optimized (e.g., the f(b) values can not be made any smaller). As previously mentioned, the system 10 starts the optimization technique by assuming the values of the weights, b, to be all equal to zero (0). These values b=0 are then substituted into EQUATION (2) and combined with the values of the credit factors 20 of borrowers 12 in the estimation database 16c to calculate the values of w. These values of w are then substituted into the EQUATION (3) and combined with the known vector of defaults Y (from column 16-2) in the estimation database 16c in order to calculate the value of the proprietary function.

The proprietary function is then checked by the step 54 in the process to see whether the value could be made smaller by a different choice of weights b. If it can be made smaller, the system 10 reruns steps 58 to 60, which calculates the new values of the next set of weights. If it cannot be made smaller as determined in step 54, i.e. any additional number of iterations cannot further decrease the value of the proprietary function f(b), then the system 10 has identified in step 56 the optimal set of weights. The optimization technique stops and the final values of the weights associated to each credit factor 20 are stored in the general memory database 16. These final weight values are called “stable weights” in step 56 of FIG. 5. These are the “optimal weights” to be used, as will be explained, in steps 36 to 38 of the flow diagram shown in FIG. 4.

As a result, when the “optimal” weights, b, are applied to the credit factors 20 in the estimation database 16 through EQUATION (1), this produces a vector of predicted probabilities of default which most closely matches the known vector of zeros and ones representing observed historical defaults and non-defaults of the borrowing entities.

The system 10, once the optimized set of weights are determined in step 54, stops using the estimation database 16c because it has managed to extract from the mass of data the optimized set of weights which can be used to calculate probabilities of default. However, the process has not ended because this set of weights has to be tested to assess the system's level of predictive accuracy if these weights, b, are applied to a new set of borrowers 12, and whether the weights, b, change dramatically if the value of the credit factors 20 are changed by small amounts.

Referring to FIG. 4, step 34 calls on the validation database 16d as set up in the input step 30. The validation database 16d is now used to test for predictive accuracy of the optimized set of weights. That is, the system 10 “loads up” or “opens up” the validation database 16d so that the optimal weights can be applied to the validation database 16d.

In step 36, the system 10 applies the set of optimal weights, b, calculated in program module 32, using EQUATION (1), to quantify the probability of default for each of the borrowers 12 in the validation database 16d. In particular, step 36 forms a vector of calculated probabilities of default, P.

A vector of zeros and ones can be formed as before to represent the defaults and non-defaults recorded in the validation database 16d because, as mentioned above, it is known before-hand whether each borrower 12 has previously defaulted. This vector of zeros and ones is then compared, in step 38, with the vector of probabilities of default, P, calculated in step 36 using EQUATION (3). A close “fit” between these two vectors, as defined by the value of the output function f(b) of EQUATION (3), determines the level of predictive accuracy of system 10.

If the level of “fit” is optimal (i.e., the change in value of the proprietary function is less or equal to 10⁻⁷ in one embodiment), the system 10 proceeds to step 40 where one more test on the weights is conducted. If the level of “fit” is not optimal, then the user is requested to check on the quality of data in the estimation database. Steps 32, 34 and 36, as described above in the illustrative embodiment of FIG. 4, assume that in the estimation database 16c, the credit factors 20 to be used have already been pre-defined by credit analysts to be those most relevant to predict default for this set of borrowers and in this particular market or economic environment.

However, there can be cases where it is not certain which credit factors 20 are to be used out of all those available. In addition there can be constraints on the size of the estimation database 16c depending on the computer platform used, and consequently only the most relevant credit factors 20 are to be retained. The system 10 therefore offers, in an embodiment, the option to select an optimal set (i.e., a specific number) of credit factors 20 using a standard technique known as “stepwise regression” whereby steps 30, 32 and 34 are first performed using any one of the credit factors 20 in the estimation database 16c, then any two, and so on (i.e., j=1, j=2, . . . , j=m within EQUATION (2)).

This process is continued until a set of credit factors 20 have been found such that if further credit factors 20 are added, the system's level of predictive accuracy measured in step 38 is not improved significantly. Consequently, this number of credit factors 20 is retained in the estimation database 16c. A technical description of Stepwise Regression is provided in Hosmer at Chapter 4, Page 87. It is acknowledged that other stepwise regression descriptions have been published.

Still referring to FIG. 4, step 40 involves a test of the stability of the weights, b, derived in steps 30 and 32. In this test, the values of the credit factors 20 in the estimation database 16c are changed simultaneously by small amounts generated randomly within, in an embodiment, a range of 0% to 1%, and steps 50 to 62 of the module 32 as shown in FIG. 5 are repeated to see if the new optimal set of weights, b, are close to the previous optimal values.

If the new optimal set of weights, b, are sufficiently close to previous optimal values the weights are sufficiently stable. That is, for example, if the resulting values of probabilities of default, P, are within 5% of their original values as calculated by applying the previous optimal values into EQUATION (1), stability is declared. If not, the system 10 provides an indication or signal to prompt the user to conduct a check on the quality of data in the estimation database 16c.

In an alternative embodiment, step 40 can involve a test of the stability of the weights, b, derived in steps 30 and 32 which ensures that the quoted accuracy of the model is not spurious and due to a fortunate sample having been chosen by chance. In this embodiment, a bootstrap algorithm which directs many mini routines to calculate weights and accuracies is used to ultimately ascertain the optimal and final weights and accuracy.

The user is first required to define the number of mini routines to be run. In an embodiment, the minimum number of routines it set to thirty. Using the input number of routines, the algorithm randomly extracts many different cross-sections of the reference database 16a. This requires the repeated generation of estimation database 16c and validation database 16d with borrowers 12 being chosen randomly using a Monte Carlo process. In an embodiment, as will be appreciated by one skilled in the relevant art(s), the Monte Carlo process can be performed using a standard Microsoft® Windows™ library function call referencing the databases 16c and 16d.

Steps 30 to 38 are then repeated for both the estimation database 16c and validation database 16d, and the set of optimal weights and their predictive accuracy is recorded. The set of weights returned by each iteration of the bootstrap algorithm is stored as a vector. A stability algorithm is then applied to select the final weight vector to be retained and the predictive accuracy of this final set of weights is returned as the accuracy of the process. The process to choose a stable set of weights is set forth in section VII below. If a stable set of weights cannot be found then the user is requested to conduct a manual check on the quality of data in the reference database 16a as indicated in FIG. 4.

If the tests of steps 38 and 40 provide satisfactory results, this means that the set of weights, b, are sufficiently accurate and stable to be used as a basis for predicting whether new borrowers 12 will default in the future. Hence, these weights, b, can be applied to the credit factors 20 for any new borrower 12 to derive its probability of default.

Probabilities of default can now be calculated for any borrower 12 with a complete set of credit factors 20 in the general memory database 16. To calculate probabilities of default in step 42 the system 10 uses the optimal weights determined and tested in the previous steps and the set of credit factors 20 available in the general memory database 16 for the respective borrowers for which the probability of default needs to be determined. The system 10 applies the above mentioned data into EQUATION (1).

In one illustrative embodiment of the present invention, the steps illustrated in FIGS. 4 and 5 can be implemented by a program in form of the source code listed in the APPENDIX and adapted to be executed by the computer 15.

### V. PROJECTIONS

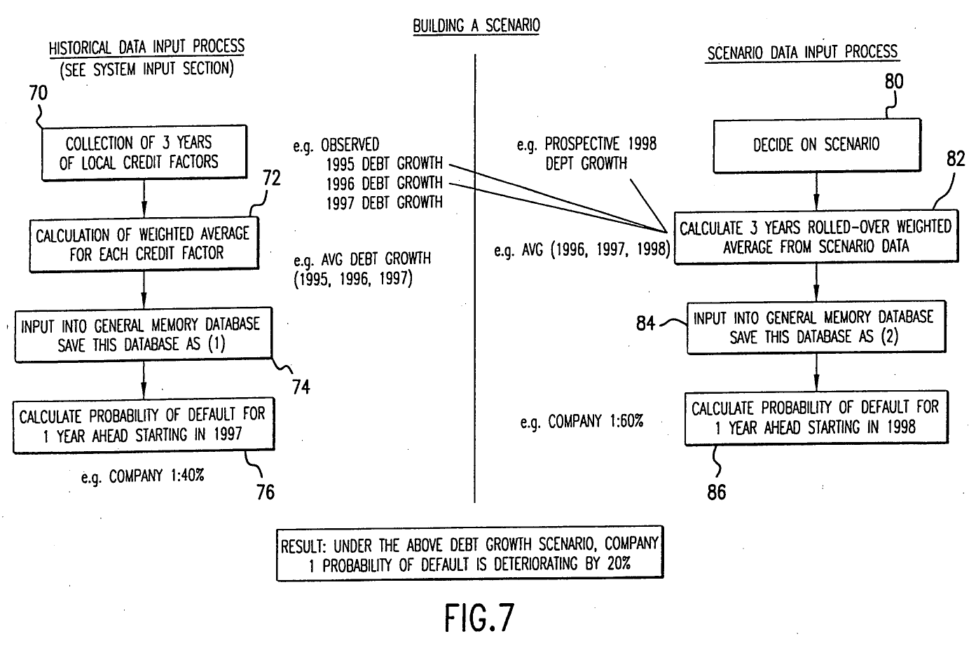

Referring to FIG. 7, the system 10 can also be used to run projections (i.e., probabilities of default under different economic scenarios) for the years to come. Because in an embodiment of the present invention, the credit factors 20 input into the system 10 in the general memory database 16 are the weighted average of the last three years of credit factors available, scenarios can be accommodated in the system 10 through the manual input in the general memory database 16 of a new “rolled-over” weighted average of future years of credit factors 20, based on how the scenario will affect future credit factors 20. Both the old version of the general memory database 16 (i.e., the one prior to the scenario shown as database (1) in step 74), and the new version of the general memory database 16 (i.e., the one containing the scenario shown as database (2) in step 84) are saved. FIG. 7, assuming the current year is 1997, illustrates how scenarios are accommodated in the system 10. Steps 70 to 74 are identical in all aspects to the data input operations as described with reference to FIGS. 1 and 3, resulting in data stored in the general memory database 16 similar to that shown in FIG. 2. Step 76 is similar in all aspects to step 42 in FIG. 4, whereas the probability of default of each company in the general memory database 16 is calculated.

An example is provided in FIG. 7 where it is assumed that the user believes that the country or any economic environment where the lending institution has extended credit will enter a recession next year, and the development in the next year will likely show rising interest rates and more occurrences of borrowers 12 unable to meet payments. A scenario in step 80, for instance, of increased debt burden for next year can be entered in the system 10 by the user assuming that the credit factors 20 for next year for all borrowers are already known as a function of previously known credit factors 20. For instance, it can be assumed by the user in this scenario that debt growth for next year is the debt growth for the current year plus 20%. The weighted average value of the credit factors 20 for next year and the previous 2 years are calculated in step 82 and input in step 84 into the general memory database 16 (with exactly the same format as described in FIG. 2).

The optimal weights, b, saved in the general memory database 16 are then applied to this credit factors 20 “scenario” information to derive in step 86 probabilities of default as defined in step 42 of FIG. 4 under the scenario hypothesis. It will be described below how the probability of default produced (with and without a scenario) can be represented graphically to facilitate their management.

### VI. OUTPUT GRAPHICS FACILITY

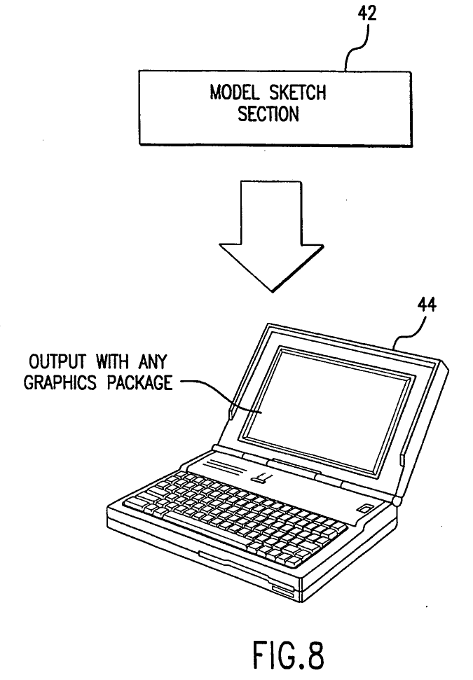

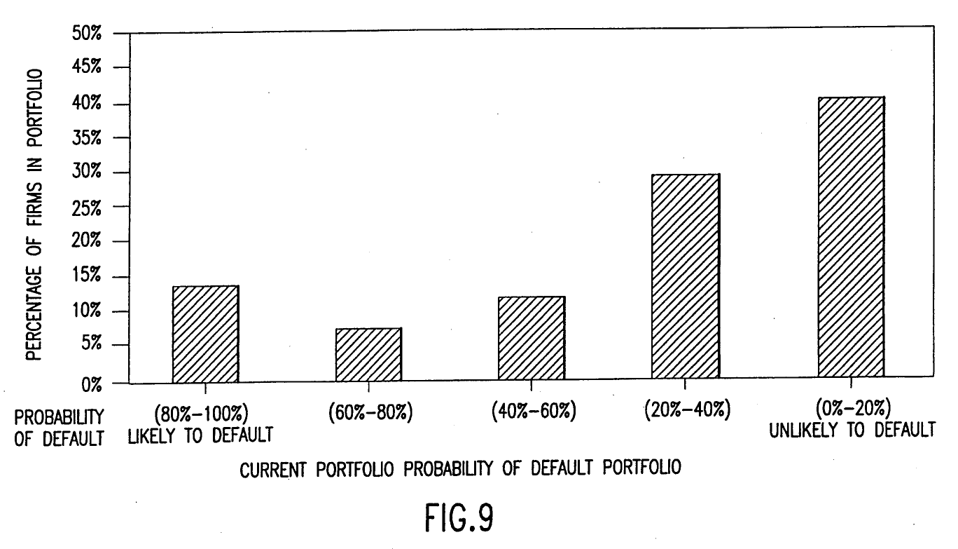

As indicated in FIG. 4 and shown in FIG. 8, the system 10 has an output graphic facility step 44. That is, the process of present invention can employ any commercially available software graphics package to graphically represent the probabilities of default calculated in step 42 as will be apparent to one skilled in the relevant art(s). The output step 44 extracts the probabilities of default, P, calculated by the system 10 in step 42 and translates them into analytical graphs for credit risk management purposes. FIG. 8 shows schematically how these graphs are produced. FIGS. 9-13 illustrate the graphs which can be produced in an embodiment of the present invention. These graphs are described below.

As the system 10 can produce the probability of default for any borrower 12 in step 42, it can also do so for a bank's portfolio of borrowers (i.e., a group of borrowers). The results from step 42 can be grouped as belonging to probability of default ranges to be defined by the user, and these groups of probability of default can tabulated in a histogram as shown in FIG. 9.

FIG. 9 represents the percentage of borrowers belonging to each defined range of probability of default. For instance approximately 14% of the number of companies for which a probability of default was calculated in step 42 have a probability of default falling into the 80% to 100% range, about 6% of the number of companies for which a probability of default was calculated fall into the 60% to 80% range, etc.

From a management perspective, the graph of FIG. 9 can be used to: (1) understand the portfolio concentration in terms of probability of default, whereby management can then define strategies to be more selective in granting credit approval such that only credit worthy Applicants will be included in the portfolio; (2) set aside provisions corresponding to client's probability of default, for example, if the bank knows that 7% of its clients have 60% probability of default, it has to put aside an amount equivalent to 60% of the notional amount of the loans granted to these 7% of clients; and (3) define strategies to diversify the bank's risk. For example, if most of the bank's clients have a 60% probability of default and the bank is concerned that there will be an economic downturn and hence current probabilities of default are likely to deteriorate in the future, it can consider diversifying to ensure that it will maintain some of its client rating in that category.

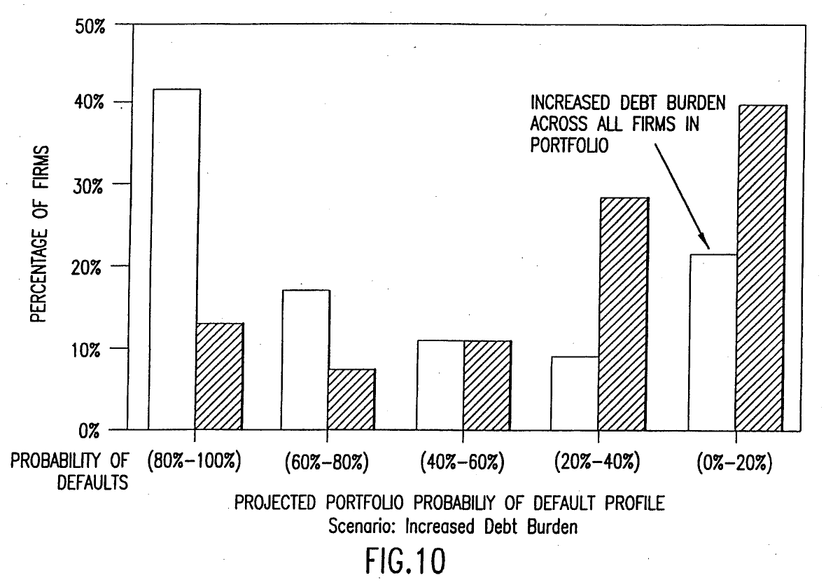

In step 42, as mentioned above, the system 10 can also be used to run projections (i.e., probabilities of default under different economic scenarios) for the years to come. FIG. 10 is the combination of FIG. 9 and the results of the scenario example described in step 42.

The graph of FIG. 10 (using the darker shade to denote scenario data) shows that the probability of default of all companies in the loan portfolio will mostly increase as a consequence of the scenario. If management feels it cannot tolerate the projected level of credit deterioration, it can take steps now to protect itself against the harmful effects of a recession.

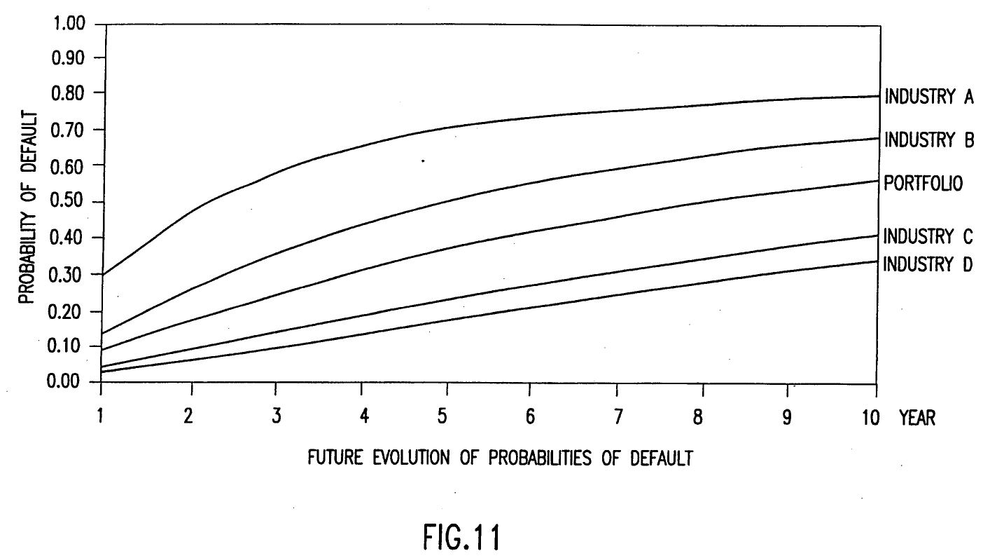

In a further application of the present invention, the lending institution can run scenarios more than one year forward for each industry or economic sector within its portfolio and obtain a picture of the future evolution of probabilities of default by industry for each year of scenario. This is achieved by using the scenario option for each year of the scenario. Probabilities of default are then calculated as described in step 42. Projections can, for instance, be inputted for a ten-year period, hence returning a ten-year probability of default profile as shown in FIG. 11. This information is particularly useful for long term planning as the bank will have some idea of the kind of loan loss provisions it may need going forward. Moreover, the information allows the bank to have a better handle in pricing future transaction. Given that the bank knows how the quality of the credit it is taking on is likely to evolve, it can include some margins in deal documents to compensate for future risks. In addition, the bank can include some covenants in its documents to better protect itself against higher risks.

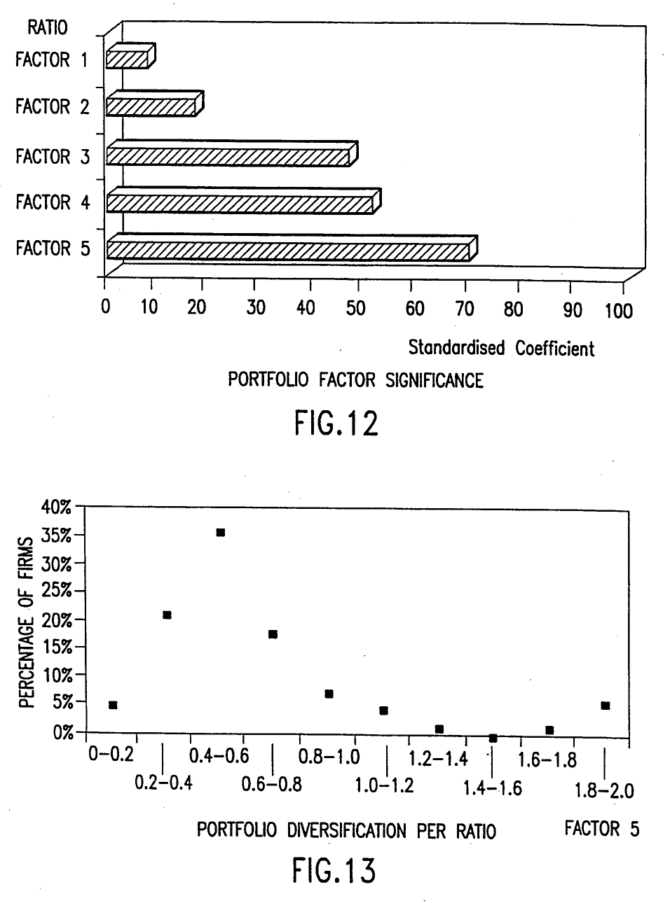

In FIG. 12, a graph of credit factors 20 that are robust predictors of probability of default and are produced by the system 10 is shown. When the optimal weights are derived in step 32, system 10 offers the option to use the stepwise regression technique as to test the relative significance of each credit factor based on the optimal weights, b, associated with each factor 20. The measure of significance used is called the “standardized coefficient,” and this is plotted on a graph as shown in FIG. 12. From the graph of FIG. 12, it can be determined that the fifth credit factor 20 is the most significant factor due to its high weight or standardized coefficient, followed by fourth, third and second credit factors 20, and so on. As understood by one skilled in the relevant art(s), standardized coefficients describe the relative importance of the independent variables in a multiple regression model. In the above described embodiment, the independent variables are the credit factors 20. To calculate standardized coefficients, one performs a regression where each variable is normalized by subtracting its mean and dividing by its estimated standard deviation. The standardized coefficients may well vary depending on the industry examined. For strategic reasons, bank management can emphasize that the top three credit factors 20 must be considered carefully when selecting future credit customers to ensure that the bank will not bear the risks of less credit worthy customers.

For further refinement, knowing that the fifth credit factor 20 is the most significant, the bank can examine the distribution of this factor for its entire portfolio of borrowers 12. This is done by extracting the value for this credit factor 20 across all borrowers in the general memory database 16 and plotting it as shown in FIG. 13. The horizontal axis of the graph of FIG. 13 is the range of values in the general memory database 16 for the credit factor 20 considered. The vertical axis is the percentage number of companies within the general memory database 16 which falls within each sub-section of the range. As FIG. 13 shows, a large number of clients, in this example, have the fifth credit factor 20 in the 0.4 to 0.6 range. In order to upgrade its credit portfolio quality, the bank must redefine its strategies to capture clients with higher ratios in its portfolio.

The system 10 of the present invention is very useful in any country or economic environment, but more specifically in emerging countries, to create previously unavailable processed information on the likely impact, in terms of probability of default for each individual company, of their known credit factors 20. Knowing a borrowers probability of default allows a bank or other lending institution to price consistently across all credit transactions (i.e., to measure the credit spread required, in a way which will remunerate adequately the lender for the credit risk taken). For instance, if a borrower has a probability of default of 60%, this means that 60% of the notional amount of the loan extended should be kept in reserve. If the cost of funding this reserve is 25% (i.e., the lender's cost of funds is 25%), then the product, 25%*60%, represents the margin which should be charged as a percentage of the loan amount to the company for receiving this loan. The system 10 will thus help identify when and by how much credit transactions are sometimes under-priced, representing “subsidies” granted to borrowers. The system 10 will as a result contribute to strengthen the marketing strategy of lenders.

Further, a borrower 12 using the system 10 is able to quantify its entire portfolio credit rating profile in terms of probability of default and, as a consequence, to define a consistent management action plan in particular with respect to reserving, documentation and credit risk management policies, for instance with the use of credit “derivatives” or similar instruments. The management of the borrower 12 can also speed up the credit analysis process, allowing credit officers to focus their time and attention on the most important character and economic issues. The system 10 will also bring comfort to management, shareholders and regulators that factual credit information has been analyzed consistently across all clients. The borrower can also assess by the use of the system 10 the impact of future changes in a borrower, through “what if” analysis. The system 10 hence enables all types of lenders to analyze credit decisions in a dynamic and forward-looking fashion.

Though applicable to any market or economic environment, the system 10 has significant use in the credit department/corporate banking department of banks in emerging countries (e.g., Asia, Latin America, Southern and Eastern Europe). The method, system, and computer program product of system 10 has particular use in emerging countries with any of the following characteristics: (1) no or illicit local corporate bond market; (2) lack of transparency of local equity market and can be illiquidity; (3) existence of a credit analysis framework within each bank (no pure name lending); (4) historical financial information available for each client (e.g., internal records or published accounting records, although a limited number of years of information can be available); and (5) clients' default experienced in the past.

A further use for the system 10 is by large corporate organizations in either emerging or developed countries to actively manage their treasury flows and take a large amount of credit risk on their own clients. A third possible use for the system 10 is by fund managers with unrated bonds portfolios anywhere in the world as a way to screen issuers less likely to default.

### VII. STABILITY PROCESSING

Referring to FIG. 4, the stability algorithm to choose a stable set of weights, in the alternative embodiment of step 40, is as follows:

At the end of each iteration of the bootstrap algorithm, the Maximum Likelihood estimates of the weights, b, and their predictive accuracy are stored. When the bootstrap algorithm has terminated after N iterations (as defined by the user) there are now N candidate weights (i.e., N vectors of weights) as the final weights to be retained by the model. For some of these vectors the optimization process dd not converge and so the weights will be very large in absolute size. In these cases, it may be that the accuracy being calculated is the default rate of the validation sample, so it may be possible to get very high accuracy, which is however spurious because the estimates of likelihoods are all zero or one. Therefore these weights are removed using the following algorithm:

For each credit factor 20 the range of values of the weights, b, for that credit factor 20 returned by the bootstrap is calculated. The standard deviation and mean of this set of values are calculated. Then each of the N weights for that credit factor 20 is standardized by subtracting the mean and dividing by the standard deviation. If the standardized value of the weight exceeds 2.5 standard deviations for any of the N vectors then this vector is removed from the candidate set of potential stable weights. This calculation is repeated for each of the credit factors.

If the candidate set of weights after this procedure is less than, for example, six, then the system 10 returns a message to the user that none of the maximum likelihood estimates are reliable to be used as a basis for predicting future default.

If at least six candidate weights are found, then the next step is to pick one final set of weights from this candidate set. First the mean accuracy of these weights is calculated. Then the mean value of each weight is calculated across the candidate set. A vector is then constructed, each of whose components are the mean values of the weights attaching to each credit factor. Thus this vector consists of values in the middle of the range of each weight. If there are M credit factors 20 then this vector consists of M components. The set of candidate vectors together with the constructed vector are then regarded as lying in a vector space of M-dimension. A metric is then defined in this vector space as follows: Let d(x,y) be the distance between the vectors x and y. EQUATION (4) then defines the standard Euclidean metric on this M-dimensional vector space as:
d(x,y)=Σ(x−y)² EQUATION (4)
Using this metric the distance between each candidate set of weights and the constructed vector of means is calculated. The set of weights closest to this vector is retained by the model as the final set of weights, and the associated predictive accuracy of that set of weights in that particular iteration of the bootstrap is returned as the final model accuracy.

Thus, the stability algorithm does not select the absolute most accurate set of weights. Instead, it returns a set of weights whose values are close to the mean values observed during the bootstrap process and whose overall accuracy is in the middle of the range. By choosing this accuracy, the model is returning the “intrinsic accuracy” of the reference database 16a. Choosing the set of weights, b, closest to the mean maximizes the chance that if the data in the reference database 16a is updated the new weights, b, will not be very significantly different from the last estimation.

Random sampling error is simulated by using a Monte Carlo technique—the reference database 16a credit data is randomly and independently perturbed by a perturbation of up to 5% of the true observed credit factor 20 level. One simulation thus produces one new reference database 16a. The likelihoods of default of each borrower in this new reference database 16a is calculated using each of the candidate weights, b. The simulation is repeated, for example, thirty times. For each candidate weight there is now a set of thirty estimates of likelihood of default for each company in the original reference database 16a. The borrower with the largest range of estimates can be identified. That final candidate weight is chosen for which this range is smallest.

Whatever the procedure used to pick stable weights, if from the bootstrap process it is found that the standard deviation of the accuracy is high (e.g., significantly greater than 10%) then even if a stable set of weights can be found, the quality of the data in the reference database 16a comes into question.

### VIII. EXAMPLE IMPLEMENTATIONS

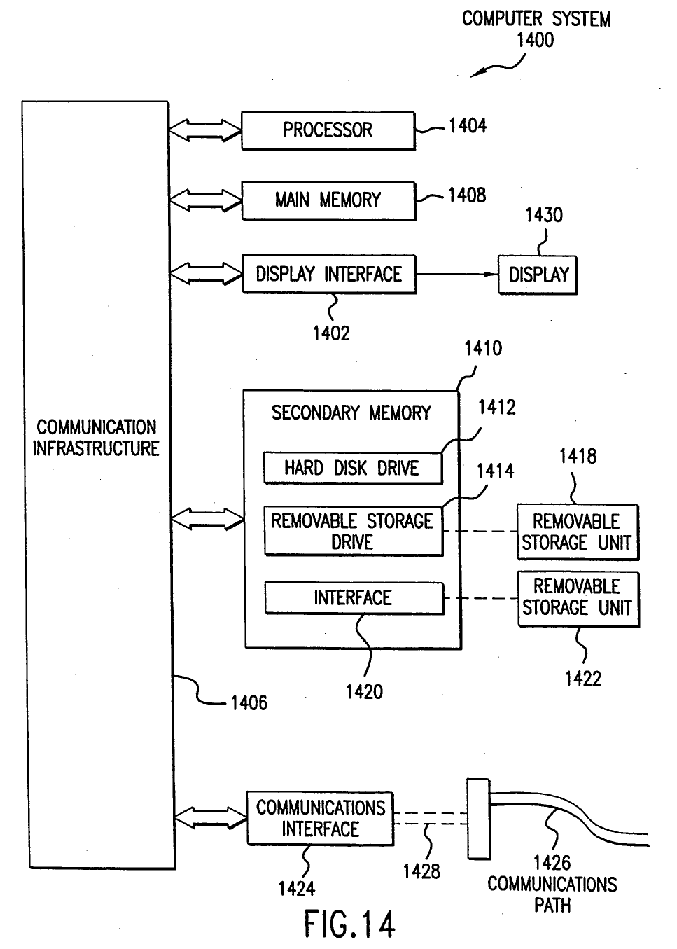

The present invention (i.e., system 10, processor 15, or any part thereof) can be implemented using hardware, software or a combination thereof and can be implemented in one or more computer systems or other processing systems. In fact, in one embodiment, the invention is directed toward one or more computer systems capable of carrying out the functionality described herein. An example of a computer system 1400 is shown in FIG. 14. The computer system 1400 includes one or more processors, such as processor 1404. The processor 1404 is connected to a communication infrastructure 1406 (e.g., a communications bus, cross-over bar, or network). Various software embodiments are described in terms of this exemplary computer system. After reading this description, it will become apparent to a person skilled in the relevant art(s) how to implement the invention using other computer systems and/or computer architectures.

Computer system 1400 can include a display interface 1405 that forwards graphics, text, and other data from the communication infrastructure 1402 (or from a frame buffer not shown) for display on the display unit 1430.

Computer system 1400 also includes a main memory 1408, preferably random access memory (RAM), and can also include a secondary memory 1410. The secondary memory 1410 can include, for example, a hard disk drive 1412 and/or a removable storage drive 1414, representing a floppy disk drive, a magnetic tape drive, an optical disk drive, etc. The removable storage drive 1414 reads from and/or writes to a removable storage unit 1418 in a well known manner. Removable storage unit 1418, represents a floppy disk, magnetic tape, optical disk, etc. which is read by and written to by removable storage drive 1414. As will be appreciated, the removable storage unit 1418 includes a computer usable storage medium having stored therein computer software and/or data.

In alternative embodiments, secondary memory 1410 can include other similar means for allowing computer programs or other instructions to be loaded into computer system 1400. Such means can include, for example, a removable storage unit 1422 and an interface 1420. Examples of such can include a program cartridge and cartridge interface (such as that found in video game devices), a removable memory chip (such as an EPROM, or PROM) and associated socket, and other removable storage units 1422 and interfaces 1420 which allow software and data to be transferred from the removable storage unit 1422 to computer system 1400.

Computer system 1400 can also include a communications interface 1424. Communications interface 1424 allows software and data to be transferred between computer system 1400 and external devices. Examples of communications interface 1424 can include a modem, a network interface (such as an Ethernet card), a communications port, a PCMCIA slot and card, etc. Software and data transferred via communications interface 1424 are in the form of signals 1428 which can be electronic, electromagnetic, optical or other signals capable of being received by communications interface 1424. These signals 1428 are provided to communications interface 1424 via a communications path (i.e., channel) 1426. This channel 1426 carries signals 1428 and can be implemented using wire or cable, fiber optics, a phone line, a cellular phone link, an RF link and other communications channels.

In this document, the terms “computer program medium” and “computer usable medium” are used to generally refer to media such as removable storage drive 1414, a hard disk installed in hard disk drive 1412, and signals 1428. These computer program products are means for providing software to computer system 1400. The invention is directed to such computer program products.

Computer programs (also called computer control logic) are stored in main memory 1408 and/or secondary memory 1410. Computer programs can also be received via communications interface 1424. Such computer programs, when executed, enable the computer system 1400 to perform the features of the present invention as discussed herein. In particular, the computer programs, when executed, enable the processor 1404 to perform the features of the present invention. Accordingly, such computer programs represent controllers of the computer system 1400.

In an embodiment where the invention is implemented using software, the software can be stored in a computer program product and loaded into computer system 1400 using removable storage drive 1414, hard drive 1412 or communications interface 1424. The control logic (software), when executed by the processor 1404, causes the processor 1404 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### IX. CONCLUSION

While various embodiments of the present invention have been described above, it should be understood that they have been presented by way of example, and not limitation. It will be apparent to persons skilled in the relevant art(s) that various changes in form and detail can be made therein without departing from the spirit and scope of the invention.

More specifically, though a number of applications of the present invention have been described above, it will be apparent to those skilled in the relevant art(s) that system 10 can be used to analyze a variety of financial risks. Changes to the method and apparatus of the present invention will occur to those skilled in the relevant art(s) to adapt the system 10 for various lenders and for various economic environments. Thus, the present invention should not be limited by any of the above-described exemplary embodiments, but should be defined only in accordance with the following claims and their equivalents.

### Appendix

### Visual Basic for Applications Source Code of the Proprietary Function (Equation (3))

‘These are the VBA proprietary functions used within the system 10

‘The functions “hide” the logistic functions used within the model.

‘Written by Alan Wong and Andy Yang, November 1997

‘© 1997 IQ Financial Systems, Inc. All rights reserved.

Option Explicit

‘Function to calculate the weighted data

‘WD1 is the result of weighting credit factors for 1 company

‘C1 is the constant from the logistic function

‘A1 are the other weights from the logistic function

‘A2 are the credit factors of a particular company

‘

Function WD1(C1 As Double, A1 As Object, A2 As Object) As Double

WD1=C1+Application.SumProduct(A1, A2)

End Function

‘Function to calculate the log likelihood function

‘LL1 is the log-likelihood, which is to be minimized to solve for

‘the weights

‘WD2 is the result of weighting the credit factors

‘Observed is the actual outcome of the company

‘i.e. 0=fail, 1=success

Function LL1(WD2 As Double, Observed As Integer) As Double

LL1=(Log(1+Exp(WD2))−Observed*WD2)

End Function

‘function to calculate the log likelihood function without

‘the WD1 function LL2 is the log-likelihood, which is to be

‘minimized to solve for the weights

‘C2 is the constant from the logistic function

‘A1 are the other weights from the logistic function

‘A2 are the credit factors of a particular company

‘i.e. 0=fail, 1=success Obs is the actual outcome of the

‘is a temporary variable containing the weighted credit factors ‘company’ WD3

Function LL2(C2 As Double, A1 As Object, A2 As Object, Obs As Integer) As Double

Dim WD3 As Double

WD3=C2+Application.SumProduct(A1, A2)

LL2=(Log(1+Exp(WD3))−Obs*WD3)

End Function

‘function to calculate logistic function

‘

‘p_{—}1 is the probability

‘WD are the weighted credit factors

‘

Function p_{—}1(WD4 As Double) As Double

p_{—}1=1/(1+Exp(−WD4))

End Function

What is claimed is:

1. A method for assessing the risk of a borrower defaulting on a financial obligation within a predefined market, comprising the steps of:
(1) receiving a first input indicative of whether the borrower has previously defaulted on a financial obligation;
(2) receiving a second input comprising a plurality of credit factors indicative of the ability of the borrower to repay a financial obligation in the predefined market;
(3) determining, using said first input and said second input, a set of weights to be placed on each of said plurality of credit factors; and
(4) calculating, using said plurality of credit factors and said set of weights, a probability of default for the borrower.

2. The method of claim 1, wherein step (3) comprises the steps of:
(a) setting each of said set of weights to a pre-determined value;
(b) calculating, using said plurality of credit factors and said set of weights, a first probability of default for the borrower;
(c) measuring said first probability of default to determine a level of fitness;
(d) determining when said level of fitness is not a good fit; and
(e) setting each of said set of weights to a new calculated value when step (d) determines said level of fitness is not a good fit.

3. The method of claim 2, wherein said pre-determined value used in step (a) is zero.

4. The method of claim 2, wherein step (b) comprises the steps of:
(a) using EQUATION (2) to calculate a value indicative of the combination of said set of weights applied to said plurality of credit factors; and
(b) using said value as input into EQUATION (1) to calculate said first probability of default for the borrower.

5. The method of claim 2, wherein step (c) comprises the step of using said first input and said first probability of default as inputs into EQUATION (3) to determine said level of fitness.

6. The method of claim 5, wherein step (d) comprises the step of determining whether said level of fitness can be minimized by more than a pre-determined amount.

7. The method of claim 6, wherein said pre-determined amount is 10⁻⁷.

8. The method of claim 2, wherein step (e) comprises the step of using maximum likelihood estimation iteration to set each of said set of weights to said new calculated value.

9. The method of claim 1, wherein step (4) comprises the steps of:
(a) using EQUATION (2) to calculate a value indicative of the combination of said set of weights applied to said plurality of credit factors; and
(b) using said value as input into EQUATION (1) to calculate said probability of default for the borrower.

10. The method of claim 1, further comprising the step of graphically outputting said probability of default for the borrower.

11. The method of claim 1, further comprising the steps of:
(5) determining, using said first input, a level of predictive accuracy for said probability of default;
(6) determining, when said level of predicative accuracy satisfies a pre-determined threshold, whether said set of weights are unstable; and
(7) generating, when step (6) determines that said set of weights are unstable, a new set of weights to be placed on each of said plurality of credit factors;
whereby said new set of weights are deemed sufficiently accurate and stable to be used as a basis for assessing the risk of default within the predefined market of different, new borrowers.

12. The method of claim 11, wherein step (5) comprises the step of using said first input and said probability of default as inputs into EQUATION (3) to determine said level of predictive accuracy for said probability of default.

13. The method of claim 11, wherein said pre-determined threshold is 10⁻⁷.

14. The method of claim 11, wherein step (6) comprises the steps of:
(a) setting each of said plurality of credit factors to a randomly selected new value wherein said new value is within a percentage range of the previous value.
(b) calculating, using said plurality of credit factors and said set of weights, a first probability of default for the borrower;
(c) measuring said first probability of default to determine a level of fitness;
(d) determining when said level of fitness is unstable; and
(e) setting each of said set of weights to a new calculated value when step (d) determines said level of fitness is unstable.

15. The method of clam 14, wherein said percentage range used in step (a) is from 0% to 1%.

16. The method of claim 11, wherein step (6) comprises the steps of:
(a) receiving a number of desired iterations input;
(b) performing a maximum likelihood estimation iteration said number of times, wherein each of said number of iterations produces a resulting set of weights; and
(c) using a stability process to select one of said number of said resulting set of weights.

17. The method of claim 11, wherein step (7) comprises the step of using maximum likelihood estimation iteration to set each of said set of weights to said new calculated value.

18. A system for assessing the risk of a plurality of borrowers defaulting on financial obligations within a predefined market, comprising:
(a) means for receiving a plurality of first inputs indicative of whether each of the borrowers have previously defaulted on a financial obligation;
(b) means for receiving a plurality of second inputs comprising a plurality of credit factors indicative of the ability of each of the borrowers to repay a financial obligation in the predefined market;
(c) means for determining, using said plurality of first inputs and said plurality of second inputs, a plurality of sets of weights to be placed on each of said plurality of credit factors for each of said borrowers; and
(d) a general database that contains a record for each borrower, wherein said record includes the corresponding one of said plurality of sets of weights, said plurality of first inputs, and said plurality of second inputs for each borrower; and
(e) means for processing said records in said general database in order to calculate a probability of default for each of the borrowers.

19. The system of claim 18, further comprising:
(f) means for graphically outputting said probability of default for each of the borrowers.

20. A computer program product comprising a computer usable medium having control logic stored therein for causing a computer to assess the risk of a borrower defaulting on a financial obligation within a predefined market, said control logic comprising:
first computer readable program code means for causing the computer to receive a first input indicative of whether the borrower has previously defaulted on a financial obligation;
second computer readable program code means for causing the computer to receive a second input comprising a plurality of credit factors indicative of the ability of the borrower to repay a financial obligation in the predefined market;
third computer readable program code means for causing the computer to determine, using said first input and said second input, a set of weights to be placed on each of said plurality of credit factors; and
fourth computer readable program code means for causing the computer to calculate, using said plurality of credit factors and said set of weights, a probability of default for the borrower.

21. The computer program product of claim 20, wherein said third computer readable program code means comprises:
fifth computer readable program code means for causing the computer to set each of said set of weights to a pre-determined value;
sixth computer readable program code means for causing the computer to calculate, using said plurality of credit factors and said set of weights, a first probability of default for the borrower;
seventh computer readable program code means for causing the computer to measure said first probability of default to determine a level of fitness;
eighth computer readable program code means for causing the computer to determine when said level of fitness is not a good fit; and
ninth computer readable program code means for causing the computer to set each of said set of weights to a new calculated value when said eighth computer readable program code means determines said level of fitness is not a good fit.

22. The computer program product of claim 20, wherein said fourth computer readable program code means comprises:
fifth computer readable program code means for causing the computer to use EQUATION (2) to calculate a value indicative of the combination of said set of weights applied to said plurality of credit factors; and
sixth computer readable program code means for causing the computer to use said value as input into EQUATION (1) to calculate said probability of default for the borrower.

23. The computer program product of claim 20, further comprising:
fifth computer readable program code means for causing the computer to graphically output said probability of default for the borrower.

24. The computer program product of claim 20, further comprising:
fifth computer readable program code means for causing the computer to determine, using said first input, a level of predictive accuracy for said probability of default;
sixth computer readable program code means for causing the computer to determine, when said level of predicative accuracy satisfies a pre-determined threshold, whether said set of weights are unstable; and
seventh computer readable program code means for causing the computer to generate, when said sixth computer readable program code means determines that said set of weights are unstable, a new set of weights to be placed on each of said plurality of credit factors;
whereby said new set of weights are deemed sufficiently accurate and stable to be used as a basis for assessing the risk of default within the predefined market of different, new borrowers.
